(19) United States
(12) Patent Application Publication
(10) Pub. No.: US 2021/0157791 A1
(43) Pub. Date: May 27, 2021

(54) IMAGE-BASED RECORD LINKAGE

(71) Applicant: Klarna Bank AB, Stockholm (SE)

(72) Inventor: Henrik Ståhl, Stockholm (SE)

(21) Appl. No.: 16/698,539

(22) Filed: Nov. 27, 2019

(51) Int. Cl. G06F 16/23; G06F 16/58; G06K 19/06; G06Q 30/00

(52) U.S. Cl. CPC G06F 16/2379; G06Q 30/018; G06K 19/06037; G06F 16/5866

(57) ABSTRACT

Data associated with an object is obtained, where the object is associated with an individual and the data includes first image data that represents the object. Second image data is obtained from a device associated with the individual. As a result of an analysis of multiple images associated with the individual that include the first image data, the second image data is determined to also represent the object. An attestation that attests to the object being associated with the individual is provided.

### BACKGROUND

Physical items are often associated with physical records attesting to an association between the physical item and a particular individual. However, the physical records may become lost, damaged, or may have been of poor quality to begin with, rendering their ability to prove the association between the physical item and the particular individual difficult, time-consuming, or even impossible. As society moves to become more paperless, such physical records may be recorded electronically; however, searching through a large number of electronic records to find a match to a physical item can likewise be time-consuming or futile. Moreover, the information needed for a complete record needed may be distributed among numerous heterogeneous computer systems, thereby adding to the difficulty of proving the association between the physical item and the particular individual.

### BRIEF DESCRIPTION OF THE DRAWINGS

Various techniques will be described with reference to the drawings, in which:

FIG. 1 illustrates an example of a record linkage system that determines an ownership certification document in accordance with an embodiment;

FIG. 2 illustrates an example of the record linkage system establishing relationships between disparate data from heterogeneous systems in accordance with an embodiment;

FIG. 3 illustrates an example of the record linkage system providing a client device with a set of potential matches to an image in accordance with an embodiment;

FIG. 4 illustrates an example of the record linkage system providing a client device with a set of potential matches to an image in accordance with an embodiment;

FIG. 5 illustrates an example of the record linkage system receiving a selection of an image match and providing an ownership certification document in accordance with an embodiment;

FIG. 6 is a flowchart that illustrates an example of accumulating disparate data in association with a physical item and an individual in accordance with an embodiment;

FIG. 7 is a flowchart that illustrates an example of obtaining and providing an ownership certification document as a result of receiving an image from an individual in accordance with an embodiment; and

FIG. 8 illustrates a computing device that may be used in accordance with at least one embodiment/an environment in which various embodiments can be implemented.

### DETAILED DESCRIPTION

Techniques and systems described below relate to a record linkage system that matches a physical item with records from multiple heterogeneous sources based on a photograph of the physical item. In some examples, “record linkage” refers to the task of finding records in a data set that refer to the same entity or item across different data sources (e.g., data files, books, websites, databases, etc.). Record linkage may be necessary to join data sets based on entities or items that may or may not share a common identifier (e.g., database key, Uniform Resource Identifier (URI), National Identification Number, etc.), which may be due to differences in record shape, storage location, curator style, or preference.

In one example, activity data associated with an individual is obtained from a first source. In the example, enumerated item data associated with the activity data is obtained from a second source. Still in the example, enrichment data corresponding to the activity data and the enumerated item data is obtained from a third source, with the enrichment data including, but not limited to, a set of images. Further in the example, image data is obtained from a client device associated with the individual. Still further in the example, a set of proposed matching images is determined by, for each image of the set of images determining whether an object depicted in the image data is potentially depicted in the image. Also in the example, the set of proposed matching images is provided to the client device for selection by the individual. Still in the example, an indication of a selected matching image from the set of proposed matching images is obtained from the client device. Finally, in the examples, an ownership certification document is provided to the client device based on the activity data, enumerated item data, and enrichment data that corresponds to the selected matching image.

In the preceding and following descriptions, various techniques are explained. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of record linkage by determining associations between various records of an individual based on a digital photograph of a physical item. Additionally, techniques described and suggested in the present disclosure improve the efficiency of digital image matching by constraining the searches to queries for images associated with a particular user, thereby improving the speed and accuracy in retrieving query results. Moreover, techniques described and suggested in the present disclosure are necessarily rooted in computer technology in order to overcome problems specifically arising with computer usability by dynamically locating various records about a physical item for a user from various sources using a digital photograph of the physical item provided by the user.

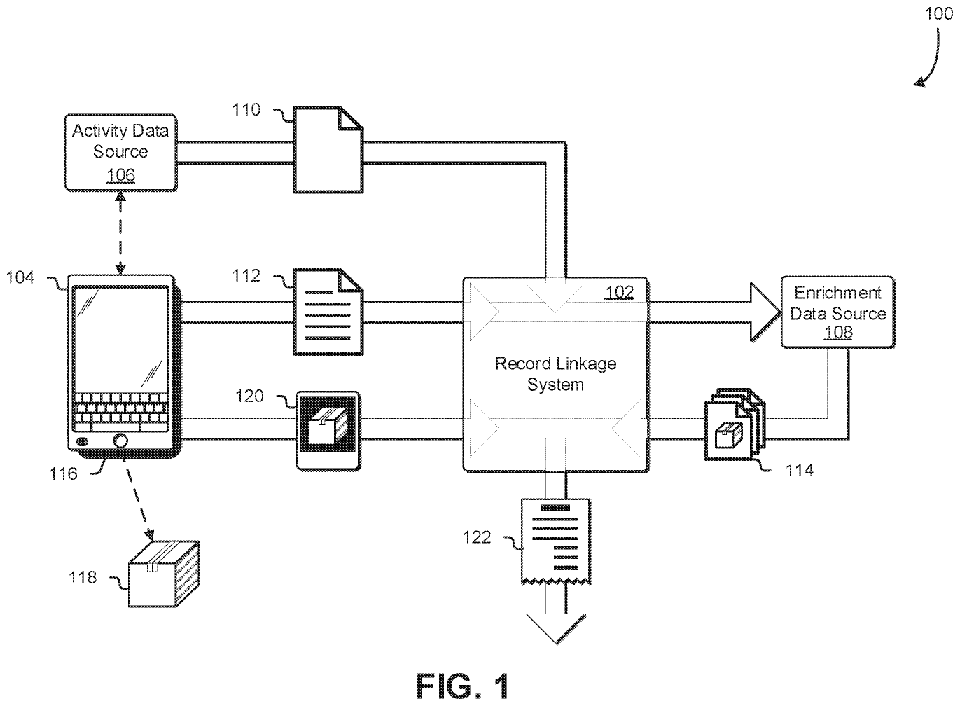

FIG. 1 illustrates an example embodiment 100 of the present disclosure. As illustrated in FIG. 1, the example embodiment 100 includes a record linkage system 102 that obtains activity data from the activity data source 106 and item data 112 from another data source such as a client device 104 of an individual. The record linkage system 102 may utilize data from the activity data and the item data 112 to make requests for additional data, referred to in the present disclosure as enrichment data 114, from another source such as an enrichment data source 108. At another time, the record linkage system 102 may receive image data 120 via the client device 104 of the individual that may include a depiction of an item as captured by an image sensor 116 of a device such as the client device 104. The record linkage system 102 may execute one or more matching algorithms to determine a set of potential matches in the enrichment data 114 corresponding to the item depicted in the image data, and upon determining a match, may determine an ownership certification document 122.

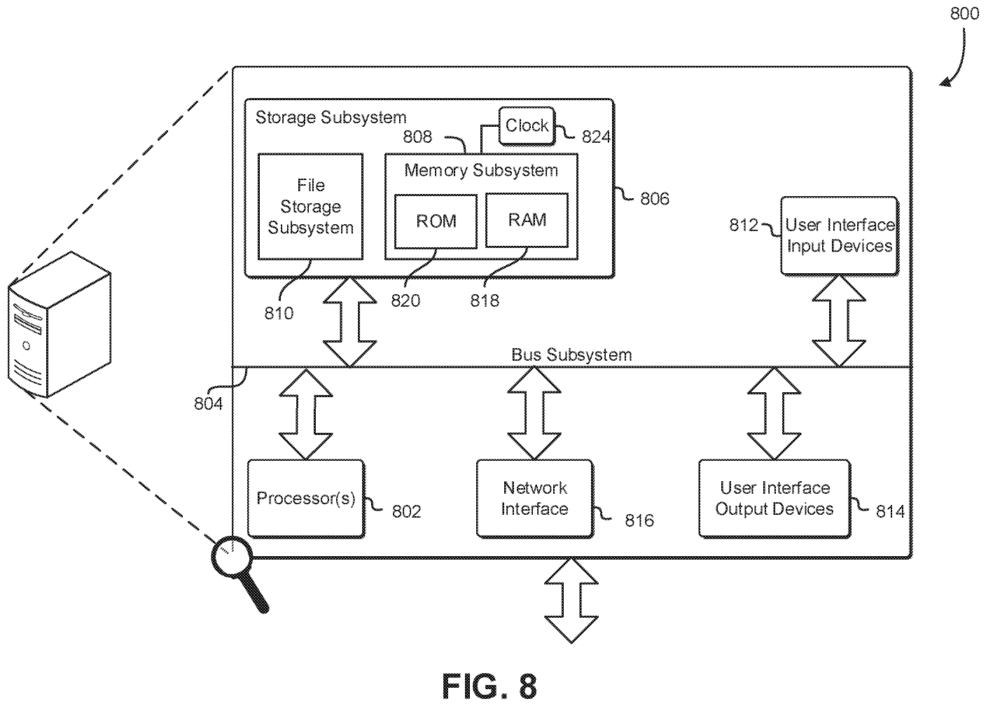

The record linkage system 102 may be a service or system provided by a service provider that performs operations to match multiple heterogeneous electronic records specific to an individual to an image of a real-life item and obtains or generates the owner certification document as proof of the relationship between the electronic records, the item, and the individual. The record linkage system 102 may be implemented by one or more computing devices similar to the computing device 800 depicted in FIG. 8. The service provider may have agreements with various data sources, such as the activity data source 106 and/or the enrichment data source 108, that grant the record linkage system 102 the ability to retrieve data from these various data sources.

The client device 104 may be one or more devices associated with an individual. For example, the client device 104 may be a smart phone, may be a laptop computer, may be a desktop computer, may be coupled to a digital camera or video recorder, may have image capture or video capture abilities integrated within the device, and so on. The client device 104 may be similar to the computing device 800 of FIG. 8.

The activity data source 106 may be a service or other entity that keeps records associated with the individual. For example, the activity data source 106 may have a record of activities, such as the activity data, that the individual has participated in. In some embodiments, the activity data source 106 is an entity from which the individual obtained the item 118. In other embodiments, the activity data source 106 is an entity, such as a payment provider, that enabled the individual to obtain the item from another entity. In some implementations, the activity data source 106 and the record linkage system 102 may be the same entity. In some examples, “entity” refers to something that exists as a particular and discrete unit that is capable of performing autonomous actions. For example, an entity may be, in a given case one or more of individuals, computing systems, applications, services, resources, or other entities authorized and capable of performing the action described.

The activity data 110 may be a set of records that includes a record related to the item 118. For example, one of the records in the activity data may be related to the item, such as a transaction performed by the individual whereby the individual obtained ownership of the item 118. The activity data may include a name of the activity data source 106, details about the individual (e.g., identity, address, other contact information, etc.), a date and/or time at which the individual obtained the item 118, and so on. The activity data, however, may lack details about the particular item involved in the activity. In some cases, the activity data may include a transaction by which the individual obtained possession of the item but did not necessarily obtain ownership of the item 118. In some other implementations, the activity data may include a transaction involving the item, but not necessarily the transaction by which the individual obtained possession or ownership of the item; for example, the activity data may serve as a record of the transaction between the individual and an entity responsible for the condition of the item, and the image data 120 may be an image attesting to damage or lack of damage to the condition of the item 118. In some examples, “ownership” refers to a state of exclusive right and control by an entity over property, such as the item 118. In some examples, “possessorship” refers to a limited state of right and control by an entity over property that is owned by another entity. In some cases, the individual may have a relationship with the activity data source 106 (shown in FIG. 1 by a dotted arrow) that stores activity data associated with the individual such that the individual may provide the record linkage system 102 with permission to access the activity data source 106 for the activity data associated with the individual.

The enrichment data source 108 may be one or more sources of data storing additional information, also referred to in the present disclosure as enrichment data 114, about the item 118. The enrichment data source 108 may include an Internet search provider, an entity from which the individual obtained the item, or other entity or service. In some implementations, the enrichment data source 108 and the activity data source 106 may be the same entity.

The enrichment data 114 may be additional data about the item not present in the activity data 110 or the item data 112. For example, at least some of the enrichment data 114 may include one or more images of the item or of an exemplary example of the item 118. The enrichment data 114 may further include a name of the item and/or other information such as a model of the item, dimensions, weight, or other specification information.

The item data 112 may be data corresponding to the item, such as an enumerated list of the items associated with a record found in the activity data. That is, the activity data 110 associated with the item may only include a date/time of the activity, identity/name of the entity with whom the individual transacted with, a physical location of where the activity occurred, total value of the activity, and/or other details; the activity data 110 may lack additional details, such as an enumerated list of each of the items that may have been involved in the activity. In contrast, the item data 112 may include an enumerated list of items involved in the activity, which may include item name, quantity of items, individual item amounts, the identity/name of the entity with whom the individual transacted with (which may or may not be an exact match to the identity/name from the activity data 110), and/or the physical location of where the activity occurred. The item data 112 may or may not include an association with the activity data 110 and/or the activity data source 106. In some cases, the item data 112 may include an association with an enrichment data source 108, such as a name of the entity from which the item was obtained. In some examples, the item data 112 may be a digital image of a paper copy of the item data 112.

The item 118 may be a physical object in the possession of the individual. The individual may seek to obtain an ownership certification document 122 certifying ownership by the individual of the item, and to that end the individual may position the image sensor 116 of the client device 104 within visible range of the item 118 to capture at least one image of the item 118 as image data 120. The item 118 may have been an object that the individual obtained from an entity but the records of the activity may be distributed among multiple heterogeneous data sources, such as the activity data source 106, the enrichment data source 108, and even the client device 104 of the individual.

As noted, the image data 120 may be one or more digital images within which the item 118 is depicted from one or more perspectives. The image data 120 may be two-dimensional image of a scene captured by an image capture device. The image data 120 may be a series of images comprising a video file or a video stream. The image data 120 may be a numeric (e.g., binary) representation of a two-dimensional image that comprise a set of picture elements (pixels). The image data 120 may contain a fixed number of rows and columns of pixels holding values that represent the brightness of a given color at that specific point. The image data 120 may be formatted according to a specific image format, such as Graphics Interchange Format (GIF), Joint Photographic Experts Group (JPEG), Portable Network Graphics (PNG), bitmap (BMP), or Tagged Image File Format (TIFF).

The image sensor 116 may be a device for electronic motion picture acquisition or electronic still picture acquisition. In some embodiments, the client device 104 serves as an image capture device within which the image sensor 116 is integrated. In other embodiments, the image sensor 116 is integrated into a separate image capture device communicatively coupled (e.g., through an Ethernet connection, wirelessly, etc.) to the client device 104. In still other embodiments, the image sensor 116 is integrated into a separate image capture device not communicatively coupled to the client device 104, but having storage (e.g., USB thumb drive, flash memory card, etc.) for storing the image data 120 which may be transferred to the client device 104. In embodiments, the image sensor 116 is a charge-coupled device (CCD) or complementary metal-oxide-semiconductor (CMOS) sensor. In embodiments, the image capture device containing the image sensor 116 includes memory, image processing capability, and/or a microphone. The device containing the image sensor 116 may be further designed to record and/or communicate a digital or analog stream of media (e.g., audio, video, text, or any combination of audio, video, or text) in a manner such that the media can be replayed or reproduced on a device designed to display such media. Examples of such image capture devices include a digital video camera, a web camera, mobile telephone, and so on.

The ownership certification document 122 may be an electronic document provided by the record linkage system 102 that attests to the item 118 being associated with the item data 112. That is, possession of the image data 120 and the item data 112 by the individual alone may be insufficient to prove that the item 118 is indeed associated with the item data 112. However, the record linkage system 102, with recourse to the activity data 110 and the enrichment data 114, is capable of determining whether the item 118 depicted in the image data 120 is indeed associated with the item data 112, and obtains or generates the ownership certification document 122 attesting to this determination. The ownership certification document 122 may, in various implementations, be presented (e.g., in electronic and/or hard copy form) to an entity associated with the activity data 110 as proof that the individual is in possession of the item 118. Thus, in some implementations, the ownership certification document 112 is the item data 122 retrieved from a repository of the record linkage system 102 and may include a digital signature by the record linkage system 102 as an attestation. In other implementations, the ownership certification document 112 may be generated by the record linkage system 102 based on one or more of the activity data 106, the item data 112, the enrichment data source 108, a digital signature, or other metadata. In some implementations, the ownership certification document 122 may include a machine-readable code, such as a barcode or a Quick Response (QR) code that can be printed out by a printer and/or scanned by a code reader to confirm ownership of the item 118 by the individual and/or other data. The ownership certification document 122 may also include information such as a quantity of the item, name of the item, a value of the item, configuration properties of the item (e.g., size, shape, color, dimensions, etc.), and/or other characteristics of the item 118.

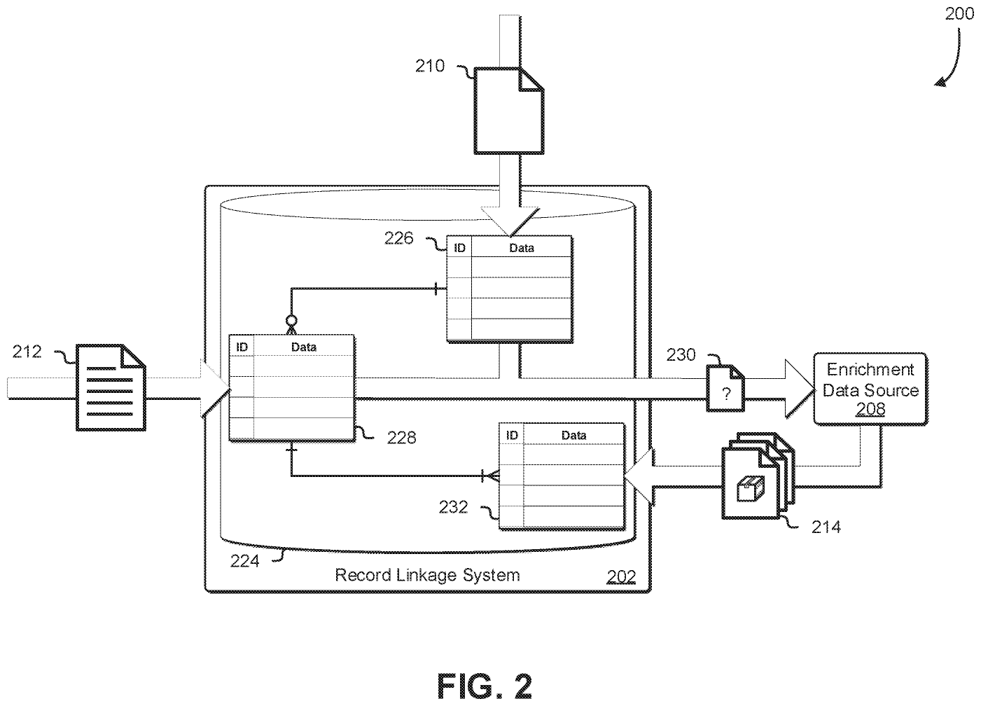

FIG. 2 illustrates an aspect of a system 200 in which an embodiment may be practiced. Specifically, FIG. 2 depicts a record linkage system 202 obtaining activity data 210, item data 212, and enrichment data 214, and storing each of these in a respective activity data table 226, an item data table 228, and an enrichment data table 232 in a data store 224. The record linkage system 202 may be similar to the record linkage system 102 of FIG. 1.

The enrichment data source 208 may be similar to the enrichment data source 108 of FIG. 1. Although FIG. 2 depicts a single enrichment data source 208, it is contemplated that the enrichment data source 208 may be comprised of multiple different data sources. For example, the enrichment data source 208 could include a website or service of an entity from which an individual obtained the item 118 of FIG. 1, could include a website or service of a different entity that itself also provides items such as the item 118, a website of a manufacturer of the item, and Internet search provider, and/or the client device 104 associated with the individual.

The data store 224 may be an organized collection of data, such as tables, queries, reports, views, and other objects maintained by the record linkage system 202 for storing at least the activity data, the item data 212, and the enrichment data 214. The data store 224 may be a repository for data objects, such as database records, flat files, and other data objects. Examples of data stores usable as the data store 224 include file systems, relational databases, non-relational databases, object-oriented databases, comma delimited files, and other files. In some implementations, the data store 424 is a distributed data store. The data store 224 illustrated in FIG. 2 includes the activity data table 226, the item data table 228, and the enrichment data table 232.

The activity data table 226 may be a collection of activity data, stored within the data store 224, obtained from one or more sources, such as the activity data source 106 of FIG. 1. In some implementations, the activity data table 226 may be an arrangement of data in rows and columns or possibly in a more complex structure. The activity data table 226 may have a column/field corresponding to individuals such that an identifier corresponding to an individual may be stored in the individual column/data field to indicate activities associated with the individual. In this manner, when the record linkage system 202 searches for activities related to an individual, the record linkage system 202 may specify to only query activities associated with the individual, thereby avoiding having to query all stored activities. The activity data table 226 may further include columns/fields corresponding to an entity other than the individual that was associated with the activity, an activity amount, an activity location, and/or entity contact information. The activity data 210 may be similar to the activity data 110 of FIG. 1.

The item data table 228 may be a collection of enumerated data, such as the item data 112 of FIG. 1, related to an activity stored in the activity data table 226. The item data table 228 may have a column/field corresponding to individuals and another column/field corresponding to an activity identifier in the activity data table 226. In this manner, searches through the item data table 228 may be limited to records associated with a particular individual and/or a particular activity in the activity data table 226. The item data table 228 may further include columns/fields corresponding to an item name, an item quantity, an item amount, and/or an item description. The item data 212 may be similar to the item data 112 of FIG. 1.

The query 230 may be at least one request, directed to one or more enrichment data sources such as the enrichment data source 208, for enrichment data 214 associated with a particular item corresponding to a record in the item data table 228 that itself corresponds to an activity recorded in the activity data table 226. The query 230 may be in any format suitable to the particular enrichment data source 208 being queried. For example, the query 230 may be an application programming interface call implementing a query string made to an enrichment data source 208 that is an Internet search provider. As another example, the query 230 may be a request (e.g., browser request, automated software agent request, etc.) for a webpage containing one or more images and/or other data about the item 218 from a provider of the item 218.

The enrichment data table 232 may be a collection of data that includes the enrichment data 214. The enrichment data table 232 may have a column/field corresponding to an item identifier in the item data table 228. In this manner, a query for enrichment data 214 may be limited to records associated with a particular individual and/or a particular item in the item data table 228. The enrichment data table 232 may include a column/field for image data 220 (e.g., one or more images of the item), and one or more images of the item 218 may be stored within the enrichment data table 232. The enrichment data table 232 may further include columns/fields corresponding to the item 218 description, recommendations, videos, and/or other data related to the item 218. The enrichment data 214 may be similar to the enrichment data 114 of FIG. 1.

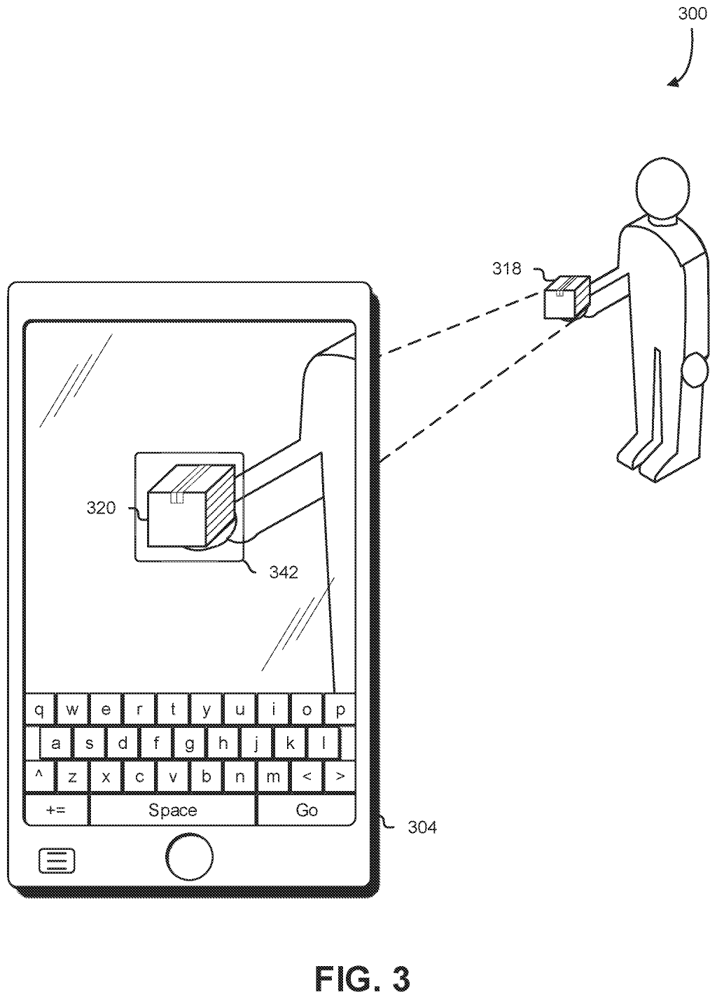

FIG. 3 illustrates an example 300 of capturing an image depicting an item 318 in accordance with an embodiment of the present disclosure. Specifically, FIG. 3 depicts a client device 304 capturing a digital depiction 320 of an item 318. An application usable to capture the digital depiction 320 may include various features to aid in capturing the digital depiction 320, such as a focus frame to aid an individual using the client device 304 to ensure that the digital depiction 320 accurately depicts the item 318.

The client device 304 may be similar to the client device 104 of FIG. 1. The client device 304 may have one or more image sensors usable to digitally capture an image of the item 318. The item 318 may be similar to the item 118 of FIG. 1. The digital depiction 320 may be a depiction of the item 318 within a digital image depicted on a display of the client device 304. The digital depiction 320 may be a preview of the image data 120 that will be captured by the client device 304.

The viewfinder 342 may be a feature of an image capture application executing on the client device 304 that provides a guide to the individual to accurately capture a depiction of the item 318. For example, the object is may be for the individual in control of the client device 304 to aim the image sensor 316 of the client device 304 at the item 318 in such a manner that the digital depiction 320 of the item 318 appears wholly or partially within the viewfinder 342. In some embodiments, the image capture application executing on the client device 304 causes the client device 304 to emit an audio signal and/or haptic feedback (e.g., vibration) when the application detects that the item 318 is insufficient focus and/or within the viewfinder 342 focus box. For example, image matching may be performed on a frame-by-frame basis until the application determines that a sufficiently close match (e.g., reaches a value relative to a similarity threshold). The image capture application may further provide a visual indication/feedback in on a viewscreen the client device to guide the user on how to tilt the camera, how to zoom, control light, and/or how to select the relevant part of the digital depiction 320 or item 318 to maximize the chance of a correct match. In some embodiments, the image capture application may collect feedback data (e.g., static feedback or dynamic feedback) for the developer of the image capture application that can be used by the developer to improve the quality of the image capture application for other users. In some cases, such feedback may be used to train a machine learning model to of the record linkage system to more accurately recognize and match image data to activity data, item data, and/or enrichment data.

In some embodiments, the application is in communication, via the client device 304, with a record linkage system 302 such as the record linkage system 102 or the record linkage system 202 of FIG. 2 such that the application may be streaming image data in the form of a series of still images of the item 318 (e.g., video stream), and the application may receive, via the client device 304, an indication of the record linkage system's failure or success in matching the item 318 depicted by the digital depiction 320 with an image in the enrichment data 314. In response to receiving the indication of failure or success, the application may cause the client device 304 to emit an audible signal and/or haptic feedback indicating such to the individual; for example, the application may buzz on an indication of failure by the record linkage system 302 to find a match to the digital depiction 320 and may beep on an indication of success by the record linkage system 302 to find a match to the digital depiction 320.

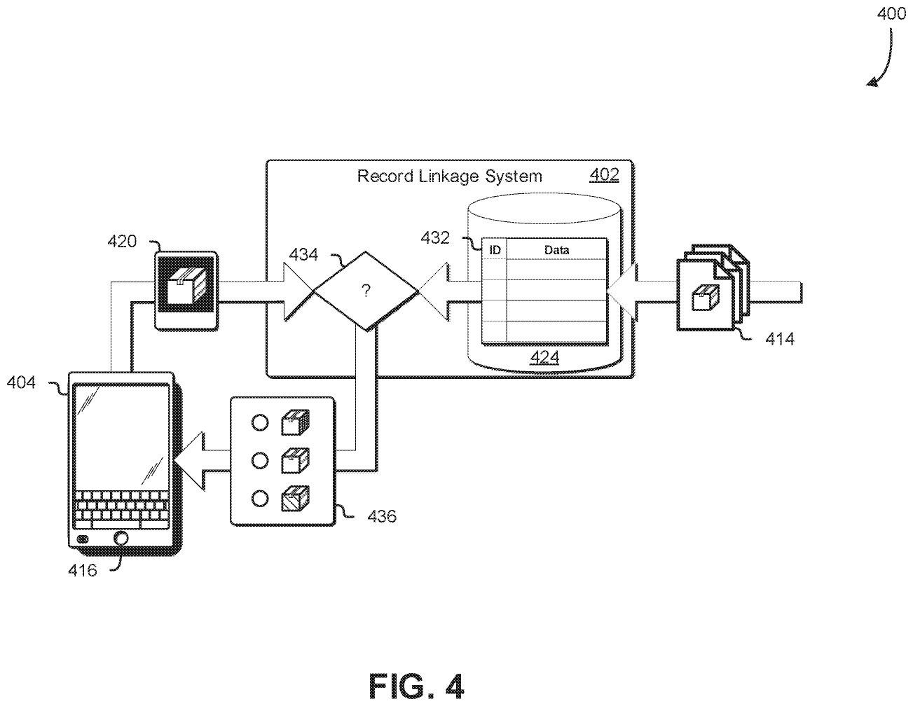

FIG. 4 illustrates an aspect of a system 400 in which an embodiment may be practiced. Specifically, FIG. 4 depicts a record linkage system 402 obtaining image data 420, attempting to match the image data 420 with enrichment data 414 in the enrichment data table 432 in the data store 424 using matching subsystem 434. Upon a determination of a set of proposed matches 436 to an item 418 depicted in the image data 420, the record linkage system 402 may provide the client device 404 with a set of proposed matches 436 from which an individual associated with the client device 404 can select one of the proposed matches that corresponds to the item 418 depicted in the item data 420. The record linkage system 402 may be similar to the record linkage system 102 and record linkage system 202 of FIGS. 1 and 2 respectively. The client device 404 may be similar to the client device 104 and client device 304 of FIGS. 1 and 3 respectively. The image sensor 416 may be similar to the image sensor 116 of FIG. 1.

The image data 420 may be similar to the image data 120 of FIG. 1. Although the present disclosure describes the individual providing image data, it is also contemplated that in some embodiments, the individual may instead provide data in other formats, such as text. In an example, the individual submits the word “jacket,” and the record linkage system 402 analyzes its records of enrichment data 414 to find records having association with the word “jacket.” In this example, the record linkage system 402 finds a model “XYZ12M” that is associated with the word jacket. In the example, the record linkage system 402 performs a query on the combination of “jacket” and “XYZ12M” to retrieve an image of the respective model of the jacket to present to the individual for confirmation that the record found in the enrichment data 414 is the correct record.

The data store 424 may be similar to the data store 224 of FIG. 2. For example, the data store 424 may be a database with a set of database tables. The enrichment data table 432 may be similar to the enrichment data table 232 of FIG. 2. The enrichment data 414 may be similar to the enrichment data 114 and the enrichment data 214 of FIGS. 1 and 2 respectively.

The matching subsystem 434 may be a hardware or software component of the record linkage system 402 that performs one or more matching algorithms (e.g., image analysis algorithms) in order to determine the set of proposed matches to the item 418 depicted in the image data 420. For example, the matching subsystem 434 may use an image segmentation algorithm to determine boundaries and shapes of objects within the image data 120 and within images of the enrichment data 414. For example, if the image depicted in the image data 120 is of an item on a bed, the image segmentation algorithm may identify and separate the item from the bed in the image. Once the boundaries and shapes of objects are determined, the matching subsystem 434 may attempt to determine whether the object depicted within the image data 120 matches an object in one or more of the images of the enrichment data 414. The matching subsystem 434 may assign a similarity score value to indicate a closeness of the shape of the object in the image data 120 to the shape of an object in an image in the enrichment data 414.

As another example, the matching subsystem 434 may perform a spectrum comparison between the image data 120 and images in the enrichment data 414 associated with the individual that submitted the image data 420. The spectrum comparison may be an image analysis algorithm that evaluates the color distribution in an image, for example by counting the frequency of occurrence of a particular color within the image. For example, if the item 418 depicted in the image data 120 is red, the color red may have a high frequency of occurrence in the image data, and the spectrum comparison may query through images in the enrichment data 414 associated with the individual to locate one or more images with a comparable frequency of occurrence of the color red. A similarity score value from the spectrum comparison may indicate a closeness of a match (e.g., by calculating a distance between frequencies in a color space of the image data 120 and frequencies in a color space of the images in the enrichment data) to the frequency of occurrence of the predominant color of the image data 120 by an image in the enrichment data 414.

As still another example, the image data 120 and the images in the enrichment data 414 may be passed as input to a set of neural network image classifiers which may assign a classification score to the images. Classification scores of images in the enrichment data 414 closest to a classification score of the image data 120 may be deemed a closer match. Note that various combinations of image matching/analysis algorithms, not limited to those described above, may be used. Each of the various image matching/analysis algorithms may produce a similarity score indicating how close an enrichment data image is to an image from the image data 120 provided by the individual. In various embodiments, an overall similarity score is determined by combining various similarity scores of the various matching/analysis algorithms. Each of the various similarity scores may be weighted in a manner that provides an optimal overall similarity score; for example, a spectrum comparison similarity score may be weighted less heavily than an image segmentation and comparison similarity score if it is determined that the image segmentation and comparison similarity score is a more accurate measure of similarity between objects in images.

The set of proposed matches 436 may be one or more images from the enrichment data 414 determined by the matching subsystem 434 to be closest matches. The matching subsystem 434 may determine, as the set of proposed matches, the image or images from the enrichment data 414 having an overall similarity score reaching a value relative to a threshold value (e.g., reaching and or exceeding a threshold). Additionally or alternatively, the matching subsystem 434 may determine, as the set of proposed matches, a number of images having the highest similarity scores (e.g., top three scoring images, top five scoring images, etc.) to the image data 420. The set of proposed matches may be provided to the application via the client device 404, and the application may present the set of proposed matches in a display of the client device 404 and allow selection from among the set of proposed matches the image that corresponds to the item 418 depicted in the image data 420.

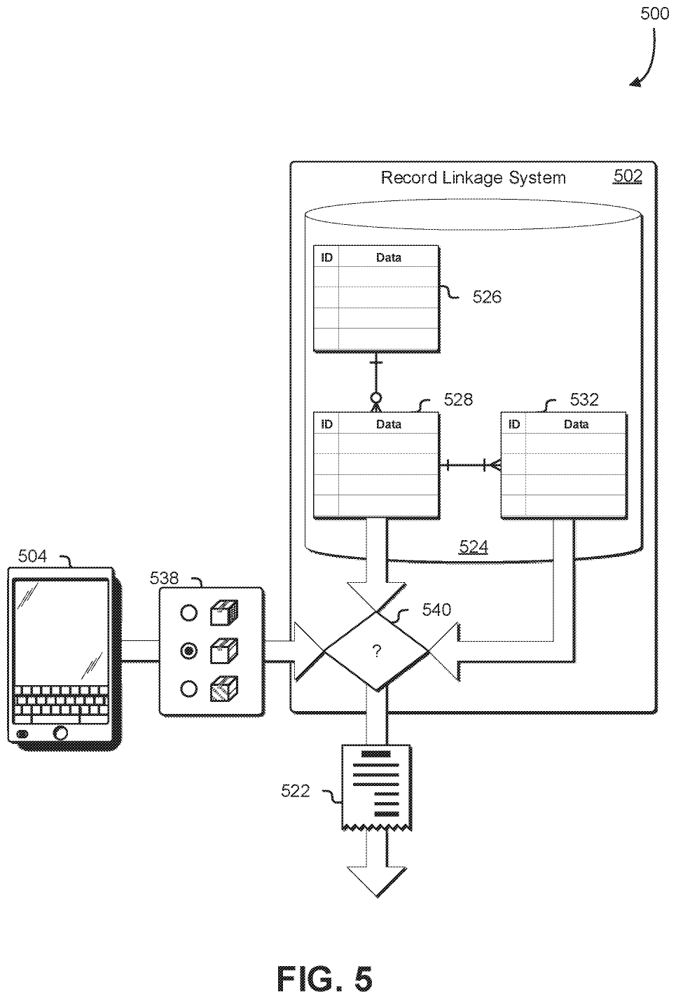

FIG. 5 illustrates an aspect of a system 500 in which an embodiment may be practiced. Specifically, FIG. 5 depicts a record linkage system 502 receiving a selected match 538 to an item 518 from a client device 504, and then obtaining, via a certification subsystem 540, an ownership certification document 522 based on the selected match 538 and data from a data store 524, such as data from an item data table 528, and enrichment data table 532, and/or an activity data table 526. The record linkage system 502 may be similar to the record linkage system 102, record linkage system 202, and record linkage system 402 of FIGS. 1, 2, and 4 respectively. The client device 504 may be similar to the client device 104, the client device 304, and the client device 404 of FIGS. 1, 3, and 4 respectively.

The data store 524 may be similar to the data store 224 and the data store 424 of FIGS. 2 and 4 respectively. For example, the data store 524 may be a database with a set of database tables. The activity data table 526 may be similar to the activity data table 226 of FIG. 2. The item data table 528 may be similar to the item data table 228 of FIG. 2. The enrichment data table 532 may be similar to the enrichment data table 232 and 432 of FIGS. 2 and 4 respectively.

The selected match 538 may be data received from the client device 504 that indicates a selection, by an individual associated with the client device 504, indicating which proposed match of the set of proposed matches corresponds to the item 518. The certification subsystem 540 may be a hardware or software component of the record linkage system 502 that, upon receiving the selected match 538 to the item, obtains (or, in some implementations, generates) the ownership certification document 522 using data from one or more tables of the data store 524 of the record linkage system 502, such as the item data table 528, the enrichment data table 532, and/or the activity data table 526. The ownership certification document 522 may be similar to the ownership certification document 522 of FIG. 1. For example, the ownership certification document 112 may the item data 122 retrieved from a repository or other data store of the record linkage system 102 as a result of the matching by the certification subsystem 540 or may be generated by the record linkage system 102 itself based on data from one or more of the activity data table 526, the item data table 528, the enrichment data table 532, or other metadata. The ownership certification document 522 may include a machine-readable code, such as a barcode or a Quick Response (QR) code that can be printed out by a printer and/or scanned by a code reader to confirm ownership of the item by the individual and/or other data.

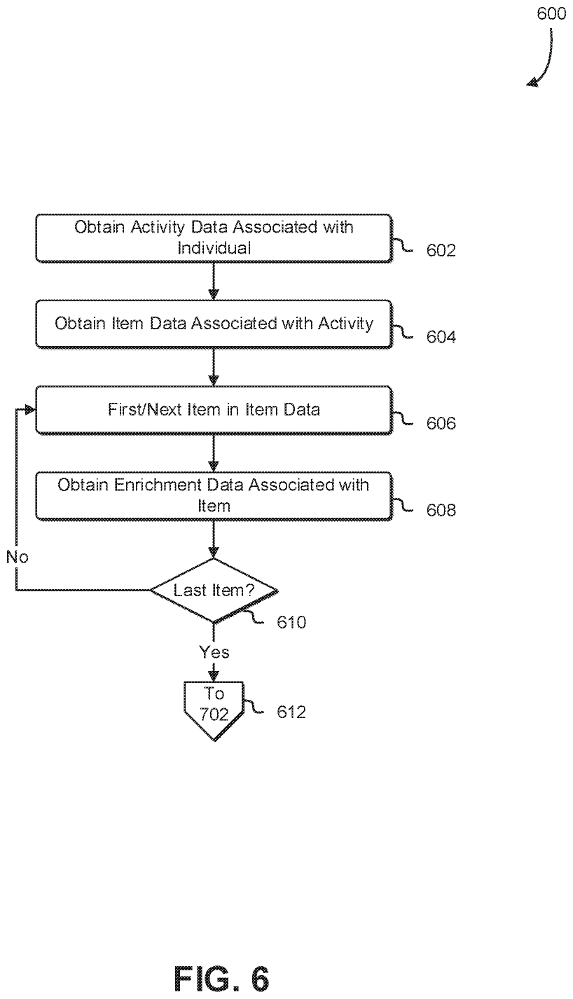

FIG. 6 is a flowchart illustrating an example of a process 600 for collecting data associated with an item and an individual in accordance with various embodiments. Some or all of the process 600 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 800 of FIG. 8. The process 600 includes a series of operations wherein activity data associated with an individual obtained from an activity data source, item data associated with the activity is obtained, and, for each item in the item data, enrichment data is obtained for the item.

In 602, the system performing the process 600 may obtain access to an activity data source and may submit a request to obtain activity data associated with an individual, such as the individual associated with the client device 104 of FIG. 1. In response to the request, the activity data source in response may provide the activity data associated with the individual. In some cases, the activity data source may be the system itself, whereas in other cases the activity data source may be a third party entity that has granted access to the system to obtain the activity data. As noted, the activity data may have a relationship to possessorship or ownership of an item by the individual, but the activity data may include basic information about the activity but may not necessarily include detailed data about the item itself.

In 604, the system performing the process 600 may obtain access to an item data source and may submit a request to obtain item data related to items involved in the activity from the item data obtained in 602. In response to the request, the item data source may provide the item data associated with the activity. The item data source in some cases may be a client device of the individual (e.g., an email confirmation stored on the client device containing item data), may be the activity data source, may be an entity that was a party to the activity but not necessarily the activity data source, may be the system itself, or may be some other third-party entity that has granted access to the system to obtain the item data. The item data may include details about the item, such as a quantity of the item, value of the item, name of the item, and/or other information (e.g., size of the item, color of the item, shape of the item, dimensions of the item, etc.). However, it is contemplated that the item data may not necessarily include information (e.g., exemplary images of the item) usable to match an image of the item with the item's corresponding item data.

In 606, the system may obtain item data of a first or next item in the item data associated with the activity. In 608, in order to obtain information usable to match an image of the item with the item data, the system performing the process 600 may obtain access to an enrichment data source and may submit a request to obtain enrichment data for each item in the item data. In response to the request, the enrichment data source may provide the enrichment data associated with the item data. The enrichment data source in some cases may be the client device of the individual, maybe the item data source, may be the system itself, or may be some other third-party entity that has granted access to the system to obtain the enrichment data. As described above, enrichment data may include one or more exemplary images of the item or at least an example of the item.

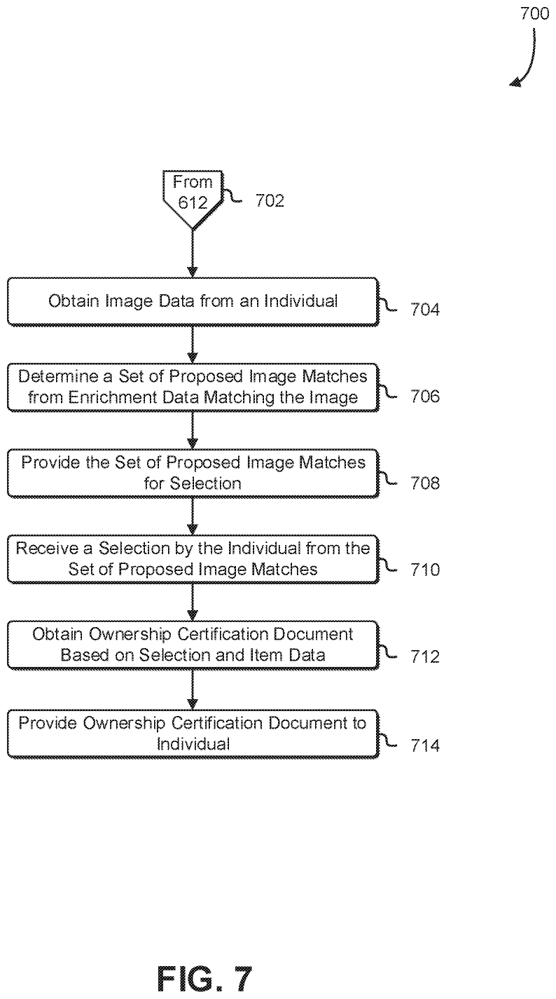

In 610, the system performing the process 600 may determine whether it has obtained enrichment data for each item listed in the item data associated with the activity. If still more items are lacking enrichment data, the system may return to 606 to obtain enrichment data for the next item. Otherwise, if the system has obtained needed enrichment data for each item in the item data associated with the activity, the system may proceed to 612 to perform the process 700 of FIG. 7. Note that the operations of 602-10 may be performed independently from the process 700; that is, the process 600 may be performed at a time prior (e.g., days, weeks, months, years, etc.) to obtaining an image provided by the individual in 704. In some cases, the operations of 602-10 may be performed contemporaneously with the completion of the activity associated with the activity data obtained in 602.

Note that the operations performed in 604-10 may be repeated for each activity within the activity data associated with the individual obtained in 602. Furthermore, note that one or more of the operations performed in 602-12 may be performed in various orders and combinations, including in parallel. For example, rather than the operations of 606-10 being performed in a looping fashion, the enrichment data obtained in 608 for each item in the item data may be requested and obtained in parallel with each other item in the item data.

FIG. 7 is a flowchart illustrating an example of a process 700 for providing an ownership certification document in response to receiving image data in accordance with various embodiments. Some or all of the process 700 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 800 of FIG. 8. The process 700 includes a series of operations wherein an image is received from an individual, a set of images is determined from enrichment data be prospective matches to the image, the set of images are provided to the individual for selection, and, upon receiving the selection from the individual, obtain or generate an owner certification document as described in the present disclosure.

In 702, the system performing the process 700 continues from 612 of process 600 of FIG. 6, such that the enrichment data, the item data, and the activity data may have already been obtained by the system. In 704, the system may receive image data from the individual, such as via a client device. The image data may include an image of an item associated with the activity in the activity data. In some cases, the image of the item may have been captured in an image capture event (e.g., a still image capture, a video capture, etc.) by the client device.

In 706, the system performing the process 700 executes one or more image matching/analysis algorithms to determine a match within a set of images stored by the system of an object depicted that matches the item depicted in an image in the image data. Note that because the item is presumed to be an item associated with the activity associated with the individual, the set of images may need only be images associated with the individual, rather than all images associated with activities stored by the system. In this manner, the set of images that the system needs to search through may be relatively small (e.g., less than 10,000), thereby reducing the amount of time needed to find a match to the item in the image data. The one or more image matching/analysis algorithms may assign a similarity score to each of the set of images that indicates a likelihood of depicting a match to the image. The image of the set of images having the best similarity score (e.g., highest, smallest, etc.) may be determined to depict the match to the item. In some cases, however, the similarity scores may be close, or multiple similarity scores may reach a value relative to (e.g., exceed, meet or exceed, etc.) a match threshold value, or none of the similarity scores may reach the value relative to the match threshold value. In such cases, the system may determine a set of proposed matches that the system determines has the greatest likelihood of depicting a match to the item. For example, the system may determine as the set of proposed matches a subset of the set of images having similarity scores that reach a value relative to the match threshold value. As another example, the system may determine as the set of proposed matches, a predetermined quantity of the set of images having the best similarity scores (e.g., top five, top 10, top three, etc.).

In 708, the system performing the process 700 provides copies of the set of proposed matches to the client device in order to allow the individual to select which of the set of proposed matches depicts a match to the item. For example, the client device may receive the proposed matches via an application executing on the client device, and the executing application may cause the set of proposed matches to be displayed in a user interface whereby the individual may select (e.g., by clicking, by tapping, or some other form of input for selection) one of the proposed matches that is a match to the item.

Thus, in 710, the system performing the process 700 receives data from the client device indicating the selection of one of the proposed matches selected by the individual. Having received the selection, in 712, the system may determine the item data (determined to correspond to one of the activities in the activity data) that corresponds to the selection, and obtain (or, in some embodiments, generate) an electronic document (the ownership certification document) that confirms that the item under the control of the individual (as shown by the individual providing the image data depicting the item) corresponds to the item associated with the image data. The system may obtain or generate the electronic document corresponding to the proposed match selected by the individual from a repository of the system storing such electronic documents, as described above in conjunction with FIGS. 1 and 5. The ownership certification document may be digitally signed by the system or generated to have some other guarantee of authenticity, and, in this way, presentation of the ownership certification document may provide proof attesting to the individual's ownership of the item as guaranteed by the system. In 714, the system may provide the electronic document to the individual by sending it to the client device.

Note that one or more of the operations performed in 702-14 may be performed in various orders and combinations, including in parallel. For example, in some implementations the operations of 708-10 may be omitted if one of the set of images has a similarity score sufficiently reaching a value relative to (sufficiently above) a threshold value that the system determines without requiring further input from the individual that the one of the set of images depicts the match to the item in the item data.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 8 is an illustrative, simplified block diagram of a computing device 800 that can be used to practice at least one embodiment of the present disclosure. In various embodiments, the computing device 800 includes any appropriate device operable to send and/or receive requests, messages, or information over an appropriate network and convey information back to a user of the device. The computing device 800 may be used to implement any of the systems illustrated and described above. For example, the computing device 800 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 800 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 8, the computing device 800 may include one or more processors 802 that, in embodiments, communicate with and are operatively coupled to a number of peripheral subsystems via a bus subsystem. In some embodiments, these peripheral subsystems include a storage subsystem 806, comprising a memory subsystem 808 and a file/disk storage subsystem 810, one or more user interface input devices 812, one or more user interface output devices 814, and a network interface subsystem 816. Such storage subsystem 806 may be used for temporary or long-term storage of information.

In some embodiments, the bus subsystem 804 may provide a mechanism for enabling the various components and subsystems of computing device 800 to communicate with each other as intended. Although the bus subsystem 804 is shown schematically as a single bus, other embodiments of the bus subsystem utilize multiple buses. The network interface subsystem 816 may provide an interface to other computing devices and networks. The network interface subsystem 816 may serve as an interface for receiving data from and transmitting data to other systems from the computing device 800. In some embodiments, the bus subsystem 804 is utilized for communicating data such as details, query strings, and so on. In an embodiment, the network interface subsystem 816 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 816 is enabled by wired and/or wireless connections and combinations thereof.

In some embodiments, the user interface input devices 812 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 800. In some embodiments, the one or more user interface output devices 814 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 800. The one or more user interface output devices 814 can be used, for example, to present user interfaces to facilitate user interaction with applications performing processes described and variations therein, when such interaction may be appropriate.

In some embodiments, the storage subsystem 806 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 806. These application modules or instructions can be executed by the one or more processors 802. In various embodiments, the storage subsystem 806 additionally provides a repository for storing data used in accordance with the present disclosure. In some embodiments, the storage subsystem 806 comprises a memory subsystem 808 and a file/disk storage subsystem 810.

In embodiments, the memory subsystem 808 includes a number of memories, such as a main random access memory (RAM) 818 for storage of instructions and data during program execution and/or a read only memory (ROM) 820, in which fixed instructions can be stored. In some embodiments, the file/disk storage subsystem 810 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 800 includes at least one local clock 824. The at least one local clock 824, in some embodiments, is a counter that represents the number of ticks that have transpired from a particular starting date and, in some embodiments, is located integrally within the computing device 800. In various embodiments, at least one local clock 824 is used to synchronize data transfers in the processors for the computing device 800 and the subsystems included therein at specific clock pulses and can be used to coordinate synchronous operations between the computing device 800 and other systems in a data center. In another embodiment, the local clock is a programmable interval timer.

The computing device 800 could be of any variety of types, including a portable computer device, tablet computer, a workstation, or any other device described below. Additionally, the computing device 800 can include another device that, in some embodiments, can be connected to the computing device 800 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 800 for processing. Due to the ever-changing nature of computers and networks, the description of the computing device 800 depicted in FIG. 8 is intended only as a specific example for purposes of illustrating the preferred embodiment of the device. Many other configurations having more or fewer components than the system depicted in FIG. 8 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and other constructions, certain illustrated embodiments thereof are shown in the drawings and have been described above in detail. It should be understood, however, that there is no intention to limit the invention to the specific form or forms disclosed but, on the contrary, the intention is to cover all modifications, other constructions and equivalents falling within the scope of the invention, as defined in the appended claims.

In some embodiments, data may be stored in a data store (not depicted), such as a database. In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 800 may include any appropriate hardware, software and firmware for integrating with a data store as needed to execute aspects of one or more applications for the computing device 800 to handle some or all of the data access and operation logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 800 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 800 may provide access to content including, but not limited to, text, graphics, audio, video, and/or other content that is provided to a user in the form of HyperText Markup Language, Extensible Markup Language (XML), JavaScript, Cascading Style Sheets (CSS), JavaScript Object Notation (JSON), and/or another appropriate language. The computing device 800 may provide the content in one or more forms including, but not limited to, forms that are perceptible to the user audibly, visually, and/or through other senses. The handling of requests and responses, as well as the delivery of content, in an embodiment, is handled by the computing device 800 using PHP: Hypertext Preprocessor (PHP), Python, Ruby, Perl, Java, HyperText Markup Language, XML, JSON, and/or another appropriate language in this example. In an embodiment, operations described as being performed by a single device are performed collectively by multiple devices that form a distributed and/or virtual system.

In an embodiment, the computing device 800 typically will include an operating system that provides executable program instructions for the general administration and operation of the computing device 800 and includes a computer-readable storage medium (e.g., a hard disk, random access memory (RAM), read only memory (ROM), etc.) storing instructions that if executed (e.g., as a result of being executed) by a processor of the computing device 800 cause or otherwise allow the computing device 800 to perform its intended functions (e.g., the functions are performed as a result of one or more processors of the computing device 800 executing instructions stored on a computer-readable storage medium).

In an embodiment, the computing device 800 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and enterprise application servers. In an embodiment, computing device 800 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 800 is capable of storing, retrieving, and accessing structured or unstructured data. In an embodiment, computing device 800 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining, from a first source, activity data associated with an individual;
obtaining, from a second source, enumerated item data associated with the activity data;
obtaining, from a third source, enrichment data corresponding to the activity data and the enumerated item data, the enrichment data including a set of images;
obtaining image data from a client device associated with the individual;
determining a set of proposed matching images by, for each image of the set of images determining whether an object depicted in the image data is potentially depicted in the image;
providing, for selection by the individual, at least a subset of the set of proposed matching images to the client device;
obtaining, from the client device, an indication of a selected matching image from at least the subset of proposed matching images; and
providing, to the client device, an ownership certification document based on the activity data, enumerated item data, and enrichment data that corresponds to the selected matching image.

2. The computer-implemented method of claim 1, wherein providing the ownership certification document includes providing the ownership certification document with a Quick Response code that associates the ownership certification document to the enumerated item data that corresponds to the object.

3. The computer-implemented method of claim 1, wherein determining the set of proposed matching images includes:
providing the image data and the set of images as input to a set of image analysis algorithms to obtain a set of similarity scores corresponding to the set of images; and
determining, to comprise the set of proposed matching images comprise, at least one image of the set of images whose respective similarity score exceed a threshold value.

4. The computer-implemented method of claim 3, wherein:
the set of image analysis algorithms is a plurality of different image analysis algorithms, each of the different image analysis algorithms outputting a similarity score indicating a likelihood of a match; and
determining the set of proposed matches includes combining similarity scores from the plurality of different image analysis algorithms to produce the respective similarity score.

5. A system, comprising:
one or more processors; and
memory including executable instructions that, if executed by the one or more processors, cause the system to:
obtain data associated with an object, the object being associated with an individual, the data including first image data that represents the object;
obtain second image data from a device associated with the individual;
as a result of an analysis of multiple images associated with the individual that include the first image data, determine that the second image data also represents the object; and
provide, to the device, an attestation based on the data that attests to the object being associated with the individual.

6. The system of claim 5, wherein the second image data is a streaming video of the object.

7. The system of claim 5, wherein the executable instructions further include instructions that further cause the system to provide an application to the device, the application, if executed, causing the device to:
provide visual feedback of the object to the individual via the device;
obtain, in response to input from the individual, the data associated with the object; and
provide the data to the system.

8. The system of claim 5, wherein the object is a physical item under the control of the individual.

9. The system of claim 5, wherein the executable instructions further include instructions that further cause the system to obtain, from a third party, the first image data.

10. The system of claim 5, wherein the data further includes a name of the object and a value of the object.

11. The system of claim 10, wherein the executable instructions that cause the system to provide the attestation further include instructions that further cause the system to provide an electronic document that includes the name of the object, the value of the object, and a date of an activity associated with the object.

12. The system of claim 5, wherein:
the analysis of the multiple images includes causing the system to generate a set of similarity scores by providing second image data and the multiple images to a set of image analysis algorithms, the set of similarity scores indicating a similarity between the second image data and each of the multiple images; and
the executable instructions that cause the system to determine that the second image data also represents the object further include instructions that further cause the system to determine, based on the set of similarity scores, an image of the multiple images that corresponds to the object associated with the individual.

13. The system of claim 12, wherein the executable instructions that cause the system to determine the image of the multiple images that corresponds to the object further include instructions that further cause the system to:
generate a set of overall similarity scores from the set of similarity scores for each of the multiple images; and
determine, based on the set of overall similarity scores, the image having an overall similarity score that indicates that the image most likely depicts the object.

14. A non-transitory computer-readable storage medium that stores executable instructions that, if executed by one or more processors of a computer system, cause the computer system to at least:
obtain a set of data corresponding to a physical item that has an association with an individual, the set of data including a first digital image depicting the physical item;
obtain a second digital image from a device associated with the individual;
determine, from sets of data that include the set of data, a set of proposed matching images depicting set of physical objects, the set of proposed matching images including the first digital image;
provide the set of proposed matching images to the device;
obtain, from the device, an indication that the first digital image corresponds to the second digital image; and
as a result of obtaining the indication, provide a certification document based on the set of data to the device, the certification document attesting to the association between the physical item and the individual.

15. The non-transitory computer-readable storage medium of claim 13,
wherein the executable instructions that cause the computer system to determine the set of proposed matching images further include instructions that further cause the computer system to:
determine a set of similarity scores by, for each of image in the set of data, causing the computer system to determine an indication of a likelihood that a physical object depicted in the image corresponds to a physical item depicted in the second digital image; and
determine the set of proposed matching images based on the set of similarity scores.

16. The non-transitory computer-readable storage medium of claim 13,
wherein the executable instructions that cause the computer system to obtain a set of data further include instructions that cause the computer system to obtain a set of item data associated with a activity performed by the individual.

17. The non-transitory computer-readable storage medium of claim 13,
wherein the set of data further includes a name of the physical item and a value of the physical item.

18. The non-transitory computer-readable storage medium of claim 13, wherein:
the executable instructions further include instructions that cause the computer system to provide, to the device, an application usable to capture a digital image as a result of execution by the device;
the executable instructions that cause the computer system to obtain the second digital image further include instructions that further cause the computer system to receive a series of still images from the device via the application; and
the executable instructions that cause the cause the computer system to determine the set of proposed matching images include instructions that further cause the computer system to:
determine that a similarity scores at least one of the series of still images indicates a match to the first digital image; and
provide an indication to the device executing the application that the match is indicated.

19. The non-transitory computer-readable storage medium of claim 18, wherein the instructions that cause the application to provide the indication to the device further cause the device to emit audio or haptic feedback in response to receiving the indication.

20. The non-transitory computer-readable storage medium of claim 13, wherein the sets of data are associated with a plurality of activities associated with the individual.

21. The non-transitory computer-readable storage medium of claim 20, wherein the set of data is further associated with an activity that caused a transfer of possessorship to the individual.
